(19) United States
(12) Patent Application Publication
(10) Pub. No.: US 2020/0176725 A1
(43) Pub. Date: Jun. 4, 2020

(54) POUCH-TYPE BATTERY CELLS AND METHODS FOR MANUFACTURING THE SAME

(71) Applicant: GM GLOBAL TECHNOLOGY OPERATIONS LLC, Detroit, MI (US)

(72) Inventors: Fang Dai, Troy, MI (US); Hongliang Wang, Sterling Heights, MI (US); Tengjiao Qi, Clinton Township, MI (US); Mei Cai, Bloomfield Hills, MI (US)

(21) Appl. No.: 16/208,952

(22) Filed: Dec. 4, 2018

(51) Int. Cl. H01M 2/02

(52) U.S. Cl. CPC H01M 2/0217; H01M 2/021; H01M 2220/20; H01M 2/0267; H01M 2/0287

(57) ABSTRACT

Disclosed are methods for manufacturing a pouch-type battery cells, and include disposing an anode and a cathode, and optionally a reference electrode, between a first pouch layer and a second pouch layer, and applying heat to the outer corrosion resistant polymer layer of the first pouch layer or the second pouch layer via a laser along a peripheral seal path forming a peripheral seal joining the first pouch layer and the second pouch layer to form a pouch encasing the anode and the cathode, and optionally the reference electrode. Each pouch layer includes an inner heat-activated polymer adhesive layer, a middle aluminum layer, and an outer corrosion resistant polymer layer. The outer corrosion resistant polymer layer of the first pouch layer and/or the second pouch layer can have a laser absorptivity of less than about 10%. The laser can have a wavelength of about 800 nanometers to about 2,000 nanometers.

### BACKGROUND

Assemblies of lithium-ion battery cells are finding increasing applications in providing motive power in automotive vehicles. Battery cells of various other chemistries, such as lithium-sulfur, are also candidates for such applications. Each cell of the battery is capable of providing an electrical potential of several volts (e.g., about three to four volts) and a direct electrical current based on the composition and mass of the electrode materials in the cell. The cell is capable of being discharged and re-charged over many cycles. A battery is assembled for an application by combining a suitable number of individual cells in a combination of electrical parallel and series connections to satisfy voltage and current requirements for a specified electric load, such as a traction motor for a vehicle.

In a battery application for an electrically powered vehicle, the assembled battery may, for example, comprise up to three hundred cells that are electrically interconnected to provide forty to four hundred volts and sufficient electrical power to an electrical traction motor to drive a vehicle. Sometimes, groups of battery cells are placed in pouches or packages for assembly and interconnection in forming a specified battery voltage and power requirement. There is a desire to reduce the cost of producing the respective elements of each electrochemical cell, and there is a continual desire to improve the function and reliability of each element of the battery.

### SUMMARY

Methods for manufacturing pouch-type battery cells are provided. The methods include disposing an anode and a cathode between a first pouch layer and a second pouch layer, and applying heat to the outer corrosion resistant polymer layer of the first pouch layer or the second pouch layer via a laser along a peripheral seal path to form a peripheral seal joining the first pouch layer and the second pouch layer to form a pouch encasing the anode and the cathode. Each pouch layer can include an inner heat-activated polymer adhesive layer, a middle aluminum layer, and an outer corrosion resistant polymer layer. The anode can have an anode tab which protrudes through the pouch and the cathode can have a cathode tab which protrudes through the pouch. The outer corrosion resistant polymer layer of the first pouch layer and/or the second pouch layer can be transparent to the laser. The outer corrosion resistant polymer layer of the first pouch layer and/or the second pouch layer can have a thickness of about 1 micrometer to about 100 micrometers. The outer corrosion resistant polymer layer of the first pouch layer and/or the second pouch layer can have a laser absorptivity of less than about 10%. The middle aluminum layer of the first pouch layer and/or the second pouch layer can have a thickness of about 50 micrometers to about 150 micrometers. The inner heat-activated polymer adhesive layer of the first pouch layer and/or the second pouch layer can have a thickness of about 1 micrometer to about 100 micrometers. The laser can have a wavelength of about 800 nanometers to about 2,000 nanometers. The laser can have a flat top beam profile. The laser can apply heat along the peripheral seal path in a transverse oscillation, elliptical oscillation, or a circular oscillation pattern.

A pouch-type battery cell can include a first pouch layer having a first inner heat-activated polymer adhesive layer, a first middle aluminum layer, and a first outer corrosion resistant polymer layer, a second pouch layer having a second inner heat-activated polymer adhesive layer, a second middle aluminum layer, and a second outer corrosion resistant polymer layer, one or more electrode pairs disposed between the first pouch layer and the second pouch layer, wherein each electrode pair includes an anode and a cathode, and a peripheral seal joining the first pouch layer and the second pouch layer to form a pouch encasing the one or more electrode pairs. The peripheral seal is formed by applying heat to the first outer corrosion resistant polymer layer or the second outer corrosion resistant polymer via a laser along a peripheral seal path. At least one anode of the one or more electrode pairs can include an anode tab which protrudes through the pouch and at least one cathode of the one or more electrode pairs can include a cathode tab which protrudes through the pouch. One or more of the first outer corrosion resistant polymer layer or the second outer corrosion resistant polymer layer can be transparent to the laser. One or more of the first outer corrosion resistant polymer layer or the second outer corrosion resistant polymer layer can have a thickness of about 1 micrometer to about 100 micrometers. One or more of the first outer corrosion resistant polymer layer or the second outer corrosion resistant polymer layer can have a laser absorptivity of less than about 10%. One or more of the first middle aluminum layer or the second middle aluminum layer can have a thickness of about 50 micrometers to about 150 micrometers. One or more of the first inner heat-activated polymer adhesive layer or the second inner heat-activated polymer adhesive layer can have a thickness of about 1 micrometer to about 100 micrometers. The peripheral seal can be formed by applying heat along the peripheral seal path via a laser having a wavelength of about 800 nanometers to about 2,000 nanometers. The peripheral seal can be formed by applying heat along the peripheral seal path via a laser having a flat top beam profile. The peripheral seal can be formed by applying heat via a laser along the peripheral seal path in a transverse oscillation, elliptical oscillation, or a circular oscillation pattern.

Pouch-type battery cells are also disclosed, and include a first pouch layer comprising a first inner heat-activated polymer adhesive layer, a first middle aluminum layer, and a first outer corrosion resistant polymer layer, a second pouch layer comprising a second inner heat-activated polymer adhesive layer, a second middle aluminum layer, and a second outer corrosion resistant polymer layer, one or more electrode pairs disposed between the first pouch layer and the second pouch layer, wherein each electrode pair includes an anode and a cathode, at least one reference electrode disposed between the first pouch layer and the second pouch layer, and a peripheral seal joining the first pouch layer and the second pouch layer to form a pouch encasing the one or more electrode pairs and the at least one reference electrode within a common volume. The peripheral seal is formed by applying heat to the first outer corrosion resistant polymer layer or the second outer corrosion resistant polymer via a laser along a peripheral seal path.

Other objects, advantages and novel features of the exemplary embodiments will become more apparent from the following detailed description of exemplary embodiments and the accompanying drawings.

### BRIEF DESCRIPTION OF THE DRAWINGS

FIG. 1 illustrates a schematic perspective view of an electric vehicle, according to one or more embodiments;

FIG. 2A illustrates a top view of a battery pouch cell, according to one or more embodiments;

FIG. 2B illustrates a top view of a battery pouch cell, according to one or more embodiments;

FIG. 3A illustrates a cross-sectional side-view of an unsealed battery pouch cell, according to one or more embodiments;

FIG. 3B illustrates a top view of a sealed battery pouch cell, according to one or more embodiments; and

FIG. 3C illustrates a top view of a sealed battery pouch cell, according to one or more embodiments.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Provided herein are battery pouch-type cells and methods for manufacturing the same. The battery pouch cells are formed using lasers to apply heat to a plurality of pouch layers in order to create a sealed pouch around one or more electrode pairs. The methods herein provide quick and efficient means to form battery pouch cells without compromising the integrity of the resulting battery pouch cells.

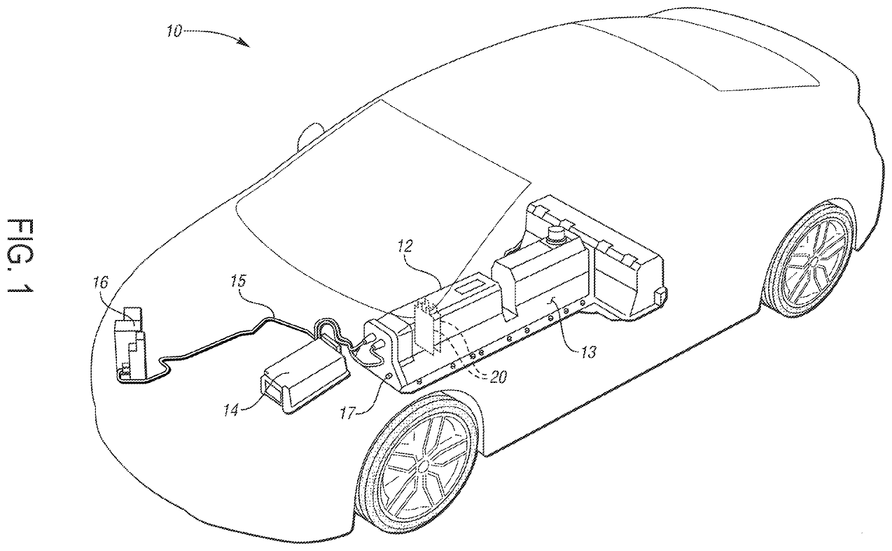

FIG. 1 illustrates a schematic perspective view of an electric vehicle 10 having a direct current (DC) battery pack 12. The battery pack 12 includes a housing 13, e.g., a T-shaped housing as shown. The battery pack 12 may contain a plurality of identically-configured battery cells 20. One possible configuration of the battery pack 12 includes at least 192 such battery cells 20 collectively outputting at least 18 kWh of electrical power, although the battery pack 12 is not limited to such an embodiment. The housing 13 may be in fluid communication with a source of coolant (not shown), e.g., via a coolant port 17, with admitted coolant circulating with respect to the battery cells 20 to help regulate a temperature of the battery cells 20 of the battery pack 12. Other embodiments may be envisioned having different shapes, power ratings, and/or active materials other than lithium ion-based chemistries, and therefore the T-shaped configuration of FIG. 1 is exemplary and non-limiting.

The electric vehicle 10 of FIG. 1 may be configured as a mobile or a stationary system of any type that may benefit from the use of electrical energy stored in the various battery cells 20. Examples of the electric vehicle 10 may include a vehicle as shown, e.g., an extended-range electric vehicle, a plug-in hybrid electric vehicle, a battery electric vehicle, or another mobile platform, robot, or stationary/non-vehicular system such as a power plant.

The electric vehicle 10 may further include an electric machine (not shown) such as a traction motor and/or a motor/generator unit that is powered by energy from the battery pack 12. Additionally, the electric vehicle 10 may include a power inverter 14 that is electrically connected to a charging module 16 via high voltage cables 15. The power inverter 14 receives alternating current (AC) power from the charging module 16 when the charging module 16 is plugged into an available charging outlet (not shown). The power inverter 14 may use pulse-width modulation or other power switching techniques to transform the AC voltage from the charging module 16 into a DC voltage suitable for charging the battery cells 20, as is well known in the art.

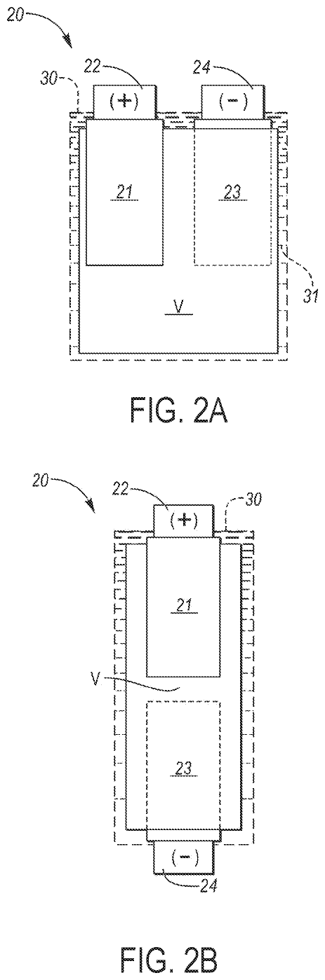

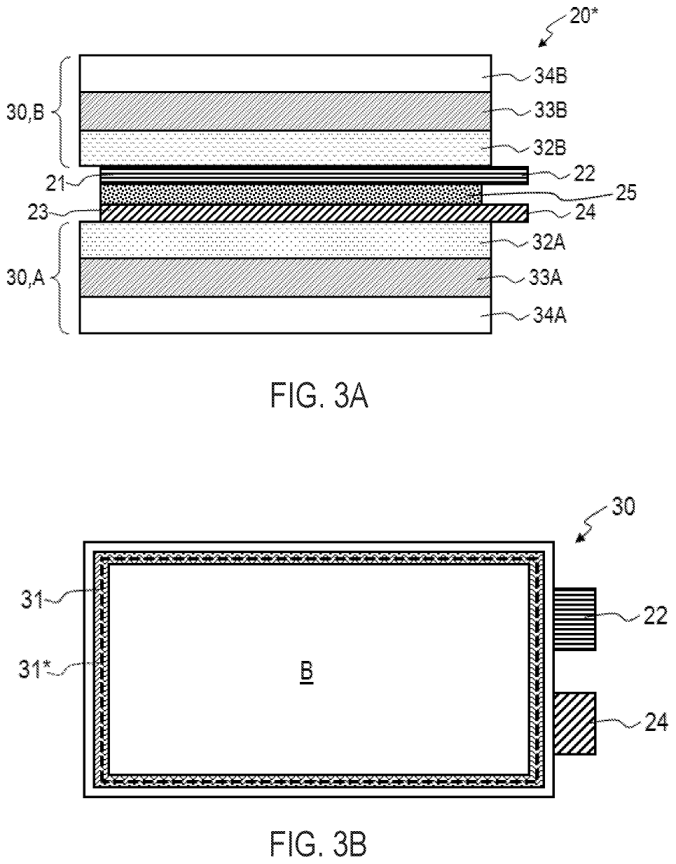

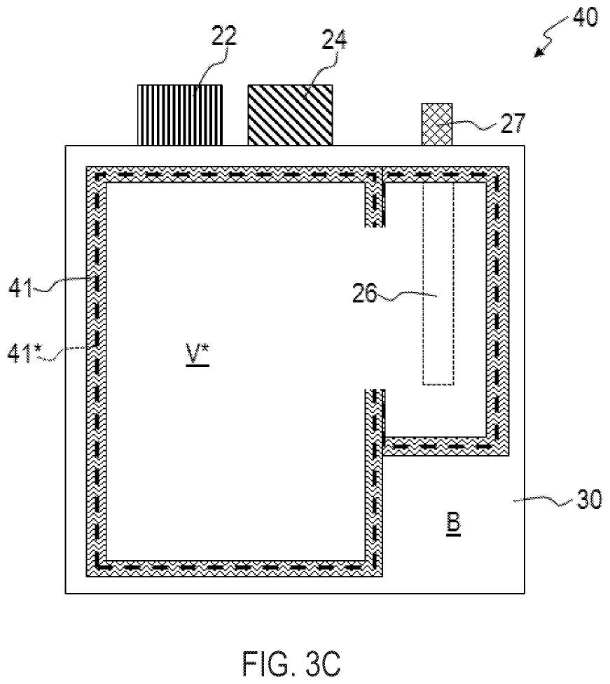

The battery pack 12 includes a plurality of pouch-type battery cells 20, two of which are shown in FIG. 1 for illustrative simplicity. FIGS. 2A-B each illustrate top views of examples of such battery cells 20. FIG. 3A illustrates a cross-sectional side-view of a battery cell 20 with an unsealed pouch 20*. FIG. 3B illustrates a top view of a sealed battery pouch cell 30, including a peripheral seal 31. Each battery cell 20 includes one or more electrode pairs, each including an anode 21 and a cathode 23, contained within a sealed pouch 30. For example, a battery cell can include 20 to 30 electrode pairs contained within the sealed pouch 30, in some embodiments. At least one anode 21 protrudes through the pouch 30 via an anode tab 22 and at least one cathode protrudes through the pouch 30 via a cathode tab 24 such that the cell 20 can be electrically coupled to one or more cells 20 and/or an external circuit (e.g., a power consumer or a charger). The pouch 30 includes a peripheral seal 31 defining an internal volume V, which is filled with electrolyte. The anode 21 and cathode 23 are electrically isolated via a separator 25 which facilitates the movement of electrolyte and ions within the electrolyte between the anode 21 and the cathode 23. Various orientations of cell electrodes are possible, including the side-by-side configuration illustrated in FIG. 2A or the end-to-end configuration illustrated in FIG. 2B, among others.

As illustrated in FIG. 3A, the pouch 30 comprises a first pouch layer A and a second pouch layer B. Each pouch layer A,B includes an inner heat-activated polymer adhesive layer 32A, 32B, a middle aluminum layer 33A, 33B, and an outer corrosion resistant polymer layer 34A,34B. One or more electrode pairs, each including an anode 21 and a cathode 23, are disposed between the first pouch layer A and the second pouch layer B. Heat is applied to the outer corrosion resistant polymer layer 34A or 34B of the first pouch layer A or the second pouch layer B via a laser along a peripheral seal path 31* (see FIG. 3B) to form a peripheral seal 31 joining the first pouch layer A and the second pouch layer B to form a pouch 30 encasing the one or more electrode pairs.

FIG. 3C illustrates a top view of a sealed battery pouch cell 40, including a peripheral seal 41. Battery pouch cell 40 comprises the aspects of battery pouch cell 20 as described above and below, and further comprises at least one reference electrode 26. At least one reference electrode 26 protrudes through the pouch 30 via a reference electrode tab 27. Battery pouch cell 40 comprises a peripheral seal 41 formed along a peripheral seal path 41* which defines a common volume V* containing the anode 21, cathode 24, and the at least one reference electrode 26. The peripheral seal path 41* is irregular, due to the inclusion of the at least one reference electrode 26 within the battery pouch cell 40. The methods described herein for manufacturing pouch-type battery cells are particularly useful for manufacturing cells such as battery pouch cell 40 with irregular peripheral seal paths 41*, and are preferable to alternative pouch manufacturing methods such as hot pressing, among others.

The outer corrosion resistant polymer layer(s) 34A and/or 34B can be generally transparent to the laser such that the outer corrosion resistant polymer layer(s) 34A and/or 34B are not damaged while the peripheral seal 31 is formed. In some embodiments, the outer corrosion resistant polymer layer(s) 34A and/or 34B can have a laser absorptivity of less than about 10%, less than about 7.5%, or less than about 5%, wherein laser absorptivity is quantified in relation to the specific laser utilized to form the peripheral seal 31. The outer corrosion resistant polymer layer(s) 34A and/or 34B can comprise a thickness of about 1 μm to about 100 μm. In some embodiments, the outer corrosion resistant polymer layer(s) 34A and/or 34B can comprise a thickness of about 10 μm. In general, the thickness of the outer corrosion resistant polymer layer(s) 34A and/or 34B is selected to provide suitable corrosion resistance protection to the respective middle aluminum layers 33A and 33B without adding undesirable weight or cost to the battery cell 20. The outer corrosion resistant polymer layer(s) 34A and/or 34B can comprise one or more polymeric materials such as polypropylene, polyethylene, high density polyethylene (HDPE), and low-density polyethylene (LDPE), among others. The outer corrosion resistant polymer layer(s) 34A and/or 34B can further comprise materials such as nylon to enhance the mechanical properties of the layer(s).

The middle aluminum layer(s) 33A and/or 33B can comprise a thickness of about 25 μm to about 200 μm, or about 50 μm to about 150 μm. In general, the thickness of the middle aluminum layer(s) 33A and/or 33B is selected to provide suitable mechanical properties without adding undesirable weight or cost to the battery cell 20. The middle aluminum layer(s) 33A and/or 33B can comprise pure aluminum, or aluminum alloys (e.g., 1100 or 3000 series aluminum alloys), and can be aluminum foils, in some embodiments.

The inner heat-activated polymer adhesive layer(s) 32A and/or 32B can comprise a thickness of about 1 μm to about 100 μm, or about 10 μm. In general, the thickness of the inner heat-activated polymer adhesive layer(s) 32A and/or 32B is selected to enable sufficient melting of the layers via the laser to alloy for the layers to subsequently adhere and form the peripheral seal 31 while not allowing direct contact between (i.e., insulating) the middle aluminum layers 33A and 33B, or between the middle aluminum layers 33A and 33B and the anode tab 22 or the cathode tab 24. The inner heat-activated polymer adhesive layer(s) 32A and/or 32B can comprise one or more polymeric materials, such as polypropylene, polyethylene, HDPE, and LDPE, among others, and additionally one or more adhesive materials, such as polyacrylate, polyacrylic, and carboxymethyl cellulose (CMC).

The laser can have a wavelength within the IR spectrum, or can have a wavelength of at least about 700 nm, at least about 800 nm, or at least about 1,000 nm. In some embodiments, the laser has a wavelength of about 800 nm to about 2,000 nm. In general, the laser is tuned to the outer corrosion resistant polymer layer(s) 34A and/or 34B, such that the above described transparency and absorptivity requirements are met. Laser contact time, intensity, shape, and patterning can also be tuned to meet all of the above defined objectives. The laser can have a gaussian or a flat top beam profile. The flat top beam profile can provide more uniform energy distribution, and further better spread energy along the peripheral seal path 31* and thereby prevent over-heating of the first and second pouch layers A,B and create a wider, stronger peripheral seal 31. Similarly, the laser can apply heat along the peripheral seal path 31* in a transverse oscillation, elliptical oscillation, or circular oscillation pattern, in order to better spread energy along the peripheral seal path 31* and thereby prevent over-heating of the first and second pouch layers A,B and create a wider, stronger peripheral seal 31.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A method for manufacturing a pouch-type battery cell, the method comprising:
disposing an anode and a cathode between a first pouch layer and a second pouch layer, wherein each pouch layer includes:
an inner heat-activated polymer adhesive layer,
a middle aluminum layer, and
an outer corrosion resistant polymer layer; and
applying heat to the outer corrosion resistant polymer layer of the first pouch layer or the second pouch layer via a laser along a peripheral seal path to form a peripheral seal joining the first pouch layer and the second pouch layer to form a pouch encasing the anode and the cathode.

2. The method of claim 1, wherein the anode comprises an anode tab which protrudes through the pouch and the cathode comprises a cathode tab which protrudes through the pouch.

3. The method of claim 1, wherein the outer corrosion resistant polymer layer of the first pouch layer and/or the second pouch layer is transparent to the laser.

4. The method of claim 1, wherein the outer corrosion resistant polymer layer of the first pouch layer and/or the second pouch layer comprises a thickness of about 1 micrometer to about 100 micrometers.

5. The method of claim 1, wherein the outer corrosion resistant polymer layer of the first pouch layer and/or the second pouch layer has a laser absorptivity of less than about 10%.

6. The method of claim 1, wherein the middle aluminum layer of the first pouch layer and/or the second pouch layer comprises a thickness of about 50 micrometers to about 150 micrometers.

7. The method of claim 1, wherein the inner heat-activated polymer adhesive layer of the first pouch layer and/or the second pouch layer comprises a thickness of about 1 micrometer to about 100 micrometers.

8. The method of claim 1, wherein the laser has a wavelength of about 800 nanometers to about 2,000 nanometers.

9. The method of claim 1, wherein the laser has a flat top beam profile.

10. The method of claim 1, wherein the laser applies heat along the peripheral seal path in a transverse oscillation, elliptical oscillation, or a circular oscillation pattern.

11. A pouch-type battery cell comprising:
a first pouch layer comprising a first inner heat-activated polymer adhesive layer, a first middle aluminum layer, and a first outer corrosion resistant polymer layer;
a second pouch layer comprising a second inner heat-activated polymer adhesive layer, a second middle aluminum layer, and a second outer corrosion resistant polymer layer;
one or more electrode pairs disposed between the first pouch layer and the second pouch layer, wherein each electrode pair includes an anode and a cathode; and
a peripheral seal joining the first pouch layer and the second pouch layer to form a pouch encasing the one or more electrode pairs, wherein the peripheral seal is formed by applying heat to the first outer corrosion resistant polymer layer or the second outer corrosion resistant polymer via a laser along a peripheral seal path.

12. The pouch-type battery cell of claim 11, wherein at least one anode of the one or more electrode pairs comprises an anode tab which protrudes through the pouch and at least one cathode of the one or more electrode pairs comprises a cathode tab which protrudes through the pouch.

13. The pouch-type battery cell of claim 11, wherein one or more of the first outer corrosion resistant polymer layer or the second outer corrosion resistant polymer layer comprises a thickness of about 1 micrometer to about 100 micrometers.

14. The pouch-type battery cell of claim 11, wherein one or more of the first outer corrosion resistant polymer layer or the second outer corrosion resistant polymer layer has a laser absorptivity of less than about 10%.

15. The pouch-type battery cell of claim 11, wherein one or more of the first middle aluminum layer or the second middle aluminum layer comprises a thickness of about 50 micrometers to about 150 micrometers.

16. The pouch-type battery cell of claim 11, wherein one or more of the first inner heat-activated polymer adhesive layer or the second inner heat-activated polymer adhesive layer comprises a thickness of about 1 micrometer to about 100 micrometers.

17. The pouch-type battery cell of claim 11, wherein the peripheral seal is formed by applying heat along the peripheral seal path via a laser having a wavelength of about 800 nanometers to about 2,000 nanometers.

18. The pouch-type battery cell of claim 11, wherein the peripheral seal is formed by applying heat along the peripheral seal path via a laser having a flat top beam profile.

19. The pouch-type battery cell of claim 11, wherein the peripheral seal is formed by applying heat via a laser along the peripheral seal path in a transverse oscillation, elliptical oscillation, or a circular oscillation pattern.

20. A pouch-type battery cell comprising:
a first pouch layer comprising a first inner heat-activated polymer adhesive layer, a first middle aluminum layer, and a first outer corrosion resistant polymer layer;
a second pouch layer comprising a second inner heat-activated polymer adhesive layer, a second middle aluminum layer, and a second outer corrosion resistant polymer layer;
one or more electrode pairs disposed between the first pouch layer and the second pouch layer, wherein each electrode pair includes an anode and a cathode;
at least one reference electrode disposed between the first pouch layer and the second pouch layer; and
a peripheral seal joining the first pouch layer and the second pouch layer to form a pouch encasing the one or more electrode pairs and the at least one reference electrode within a common volume, wherein the peripheral seal is formed by applying heat to the first outer corrosion resistant polymer layer or the second outer corrosion resistant polymer via a laser along a peripheral seal path.
